(19) United States
(12) Patent Application Publication
(10) Pub. No.: US 2023/0385411 A1
(43) Pub. Date: Nov. 30, 2023

(54) SYSTEMS AND METHODS FOR SIDE-CHANNEL MONITORING OF A PROCESSOR ON A COMMUNICATION NETWORK

(71) Applicant: Palitronica Inc., Kitchener (CA)

(72) Inventors: Carlos Moreno, Waterloo (CA); Sebastian Fischmeister, Waterloo (CA)

(21) Appl. No.: 18/203,004

(22) Filed: May 29, 2023

Related U.S. Application Data
(60) Provisional application No. 63/346,923, filed on May 30, 2022.

(51) Int. Cl. G06F 21/55

(52) U.S. Cl. CPC G06F 21/556; G06F 21/554

(57) ABSTRACT

Systems and methods for monitoring at least one control processor connected to a communication network are disclosed. The methods involve generating at least one program trace signal from at least one side-channel of the at least one device processor; and operating at least one monitoring processor to: collect the at least one program trace signal for the at least one device processor; compare the at least one program trace signal with at least one reference program trace signal to determine a score associated with at least one reference activity for the at least one device processor; and generate a notification comprising the score associated with the at least one reference activity for the at least one device processor. The at least one reference activity corresponding to the at least one reference program trace signal.

### CROSS-REFERENCE TO RELATED APPLICATIONS

This application claims priority from U.S. Provisional Patent Application No. 63/346,923, entitled “Method and Apparatus for Non-Intrusive Logs and Telemetry Validation Through Side-Channel Monitoring”, filed on May 30, 2022. The entire contents of U.S. Provisional Patent Application No. 63/346,923 are hereby incorporated by reference for all purposes.

### FIELD

The embodiments described herein relate to the field of computing systems, and in particular, side-channel analysis of computing systems for cybersecurity.

### BACKGROUND

Security and safety can be essential aspects of computing systems, especially safety-critical systems, and in view of the ever-increasing connectivity of such systems. Modern intrusion detection systems (IDS), security information and event management systems (SIEM systems), and security orchestration, automation, and response systems (SOAR systems) can have limited effectiveness as a cybersecurity tool because they rely on data obtained through the nominal channels of a target computing system.

For example, a network-based IDS inspects network traffic, analyzes the data being transmitted over the network, and determines the state of the target system based on such nominal channel data. As well, host-based IDS can analyze event log files of a target system and draws conclusions about the target system based on the information obtained from the event log files. However, such nominal channel data can be controlled or manipulated by a remote attacker once they gain access to the target system. As such, nominal channel data is unreliable. Similarly, telemetry data can be tampered with by a remote attacker to mislead the IDS into determining that the target system is normal. It would be advantageous to monitor systems with more reliable data that is not vulnerable to manipulation or tampering.

### SUMMARY

The various embodiments described herein generally relate to side-channel monitoring systems and methods of operating thereof. The disclosed methods and systems can relate to monitoring computing systems. The disclosed methods and systems can also relate to validating telemetry data and/or event data of computing systems. Validating telemetry data and/or event data can uncover forged telemetry data and/or event data, and uncover undocumented functionality on such systems. Validating telemetry data and/or event data can enhance the effectiveness of IDS, SIEM, and SOAR systems.

In accordance with an example embodiment, a system for monitoring at least one device processor connected to a communication network is provided. The system can include at least one detector operable to generate at least one program trace signal from at least one side-channel of the at least one device processor; and at least one monitoring processor in communication with the detector. The at least one monitoring processor can be operable to: collect the at least one program trace signal for the at least one device processor from the at least one detector; compare the at least one program trace signal with at least one reference program trace signal to determine a score associated with at least one reference activity for the at least one device processor; and generate a notification comprising the score associated with the at least one reference activity for the at least one device processor. The at least one reference activity corresponding to the at least one reference program trace signal.

In some embodiments, the at least one reference activity can include an event; and the score can include a likelihood of the event occurring on the at least one device processor.

In some embodiments, the at least one reference activity can include a metric; and the score can include an estimated value of the metric measurable at the at least one device processor.

In some embodiments, the at least one monitoring processor can be operable to continuously collect the at least one program trace signal for the at least one device processor.

In some embodiments, the at least one monitoring processor can be operable to: determine whether the score associated with the at least one reference activity for the at least one device processor exceeds a predetermined threshold value; and generate the notification in response to determining that the score associated with the at least one reference activity for the at least one device processor exceeds the predetermined threshold value.

In some embodiments, the at least one monitoring processor is operable to transmit the notification to another computing device.

In some embodiments, the other computing device comprises one or more of an intrusion detection system (IDS), a security information and event management system (SIEM system), or a security orchestration, automation, and response system (SOAR system).

In some embodiments, the at least one monitoring processor can be operable to: receive a query for a score associated with a particular reference activity of the at least one reference activity; compare the at least one program trace signal with the reference program trace signal corresponding to the particular reference activity to determine a score associated with the particular reference activity; and generate the notification in response to receiving the query. The notification can include the score associated with the particular reference activity.

In some embodiments, the at least one monitoring processor can be operable to: determine whether the score associated with the at least one reference activity correlates to nominal channel data of the at least one device processor; and generate the notification in response to determining that the score associated with the at least one reference activity does not correlate to the nominal channel data.

In some embodiments, the nominal channel data can include one or more of event data logged at the at least one device processor or telemetry data measured at the at least one device processor.

In some embodiments, the at least one side-channel can include one or more of a power consumption, an electromagnetic emission, a magnetic side-channel, an acoustic emanation, or an ultrasound emanation of the at least one device processor.

In some embodiments, the at least one reference activity can include a plurality of reference activities; the at least one reference program trace signal can include a plurality of reference program trace signals; and each reference activity of the plurality of reference activities corresponds to a reference program trace signal of the plurality of reference program trace signals.

In some embodiments, the at least one device processor can include a first device processor and at least another device processor; and the at least one monitoring processor can be operable to further determine the score associated with the at least one reference activity for the first device processor based on a comparison of a program trace signal of the first device processor with a program trace signal of the at least another device processor.

In another broad aspect, a method for monitoring at least one device processor connected to a communication network is provided. The method can involve generating at least one program trace signal from at least one side-channel of the at least one device processor; and operating at least one monitoring processor to: collect the at least one program trace signal for the at least one device processor; compare the at least one program trace signal with at least one reference program trace signal to determine a score associated with at least one reference activity for the at least one device processor; and generate a notification comprising the score associated with the at least one reference activity for the at least one device processor. The at least one reference activity can correspond to the at least one reference program trace signal.

In some embodiments, the at least one reference activity can include an event; and the score can include a likelihood of the event occurring on the at least one device processor.

In some embodiments, the at least one reference activity can include a metric; and the score can include an estimated value of the metric measurable on the at least one device processor.

In some embodiments, the method can involve operating the at least one monitoring processor to continuously collect the at least one program trace signal for the at least one device processor.

In some embodiments, the method can involve operating the at least one monitoring processor to: determine whether the score associated with the at least one reference activity for the at least one device processor exceeds a predetermined threshold value; and generate the notification in response to determining that the score associated with the at least one reference activity for the at least one device processor exceeds the predetermined threshold value.

In some embodiments, the method can involve operating the at least one monitoring processor to transmit the notification to another computing device.

In some embodiments, the other computing device comprises one or more of an intrusion detection system (IDS), a security information and event management system (SIEM system), or a security orchestration, automation, and response system (SOAR system.

In some embodiments, the method can involve operating the at least one monitoring processor to: receive a query for a score associated with a particular reference activity of the at least one reference activity; compare the at least one program trace signal with the reference program trace signal corresponding to the particular reference activity to determine a score associated with the particular reference activity; and generate the notification in response to receiving the query, the notification comprising the score associated with the particular reference activity.

In some embodiments, the method can involve operating the at least one monitoring processor to: determine whether the score associated with the at least one reference activity correlates to nominal channel data of the at least one device processor; and generate the notification in response to determining that the score associated with the at least one reference activity does not correlate to the nominal channel data.

In some embodiments, the nominal channel data can include one or more of event data logged at the at least one device processor or telemetry data measured at the at least one device processor.

In some embodiments, the at least one side-channel can include one or more of a power consumption, an electromagnetic emission, a magnetic side-channel, an acoustic emanation, or an ultrasound emanation of the at least one device processor.

In some embodiments, the at least one reference activity can include a plurality of reference activities; the at least one reference program trace signal can include a plurality of reference program trace signals; and each reference activity of the plurality of reference activities corresponds to a reference program trace signal of the plurality of reference program trace signals.

In some embodiments, the at least one device processor can include a first device processor and at least another device processor; and the method can involve operating the at least one monitoring processor to further determine the score associated with the at least one reference activity for the first device processor based on a comparison of a program trace signal of the first device processor with a program trace signal of the at least another device processor.

### BRIEF DESCRIPTIONS OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 depicts an example power-tracing detector for a computing system, in accordance with at least one embodiment;

FIG. 2 depicts an example electromagnetic emissions tracing detector for a computing system, in accordance with at least one embodiment;

FIG. 3 depicts an example system for side-channel monitoring of at least one device processor connected to a communication network, in accordance with at least one embodiment; and

FIG. 4 depicts a flowchart of a method for side-channel monitoring of a device processor connected to a communication network, in accordance with at least one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

The various embodiments described herein generally relate to methods (and associated systems configured to implement the methods) for side-channel monitoring of at least one processor connected to a communication network.

Side-channel monitoring involves capturing involuntary emissions (i.e., side-channels) of a processor (i.e., a processing unit), such as power consumption, electromagnetic (EM) emissions, magnetic field, acoustic, or ultrasound emanations. Power consumption, EM emission measurements, magnetic field measurements, acoustic emanation measurements, and ultrasound emanation measurements as a function of time can be referred to as power traces, EM emissions traces, magnetic traces, acoustic traces, or ultrasound traces.

Monitoring side-channels of a target computing system as it operates, that is, as it executes a program, allows for non-intrusive program tracing, or more generally, capturing program traces. The program traces can be correlated to program code executed by the target computing system or expected behavior of the electronic device during the program trace, in order to determine the events occurring on the target computing system.

Thus, data obtained from side-channel monitoring can be correlated to the internal state of the target computing system, which is physically inaccessible to remote attackers, and thus cannot be altered or manipulated by a remote attacker. Side-channel monitoring of a system can provide more reliable data about the target computer system than that obtained via primary channels of the target computing system. Data obtained from side-channel monitoring can be used instead of or in addition to data obtained from primary channels. For example, side-channels monitoring can be used to validate data used by IDS, SIEM or SOAR systems, thus improving the effectiveness of such systems.

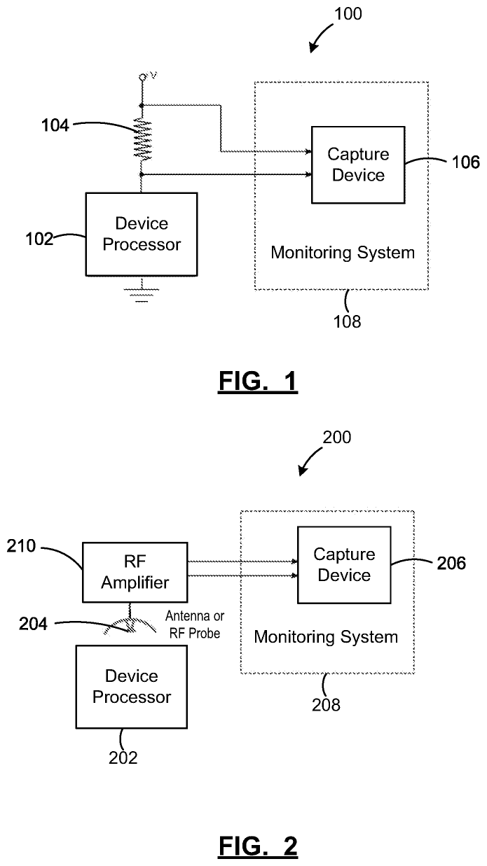

Referring to FIG. 1, shown therein is a diagram of a detector 100 for obtaining a power consumption program trace of a processor, that is a device processor 102, in accordance with at least one embodiment. The device processor 102 can include any electronic device, computer-based device, computing system, or embedded computing system. In some embodiments, the device processor 102 can be a microprocessor, a memory chip, an interface circuit, a processing unit, a CPU, or an electronic control unit.

As shown in FIG. 1, the detector 100 includes a resistor 104 and a capture device 106. The resistor 104 can be placed in series with the power input line of the device processor 102. An analog signal indicative of the power consumption of the device processor 102, or the program trace, can be obtained by measuring current or voltage across the resistor 104.

The capture device 106 can measure current across the resistor 104 to obtain the program trace. In addition, the capture device 106 can digitize the program trace. In some embodiments, the capture device 106 can be a contactless current sensor. In some embodiments, the capture device 106 can include an analog-to-digital converter. In some embodiments, the capture device 106 can be a sound card, oscilloscope, or a digital oscilloscope. The program trace obtained by capture device 106 can be used by the monitoring system 108 for validating telemetry data or event data of the device processor 102. Although not shown in FIG. 1, the monitoring system 108 can include a monitoring processor, a communication component, and a storage component.

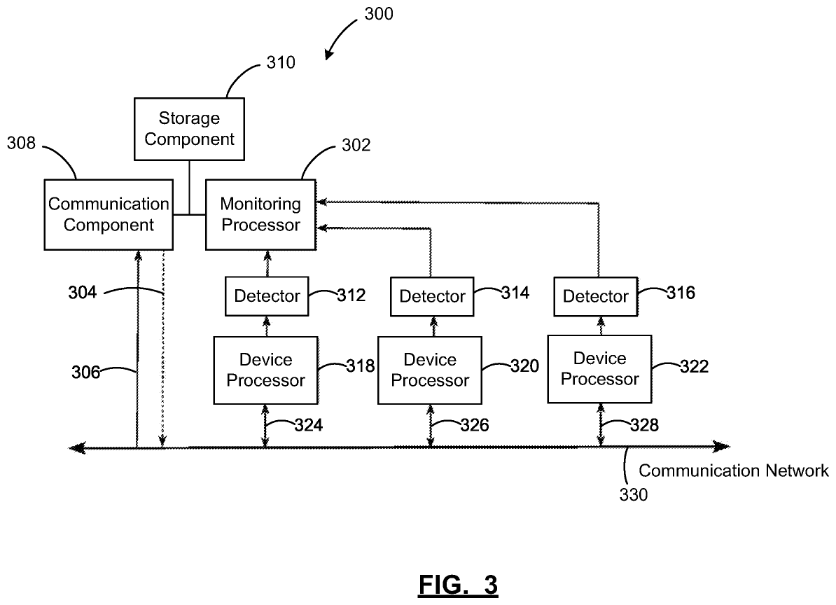

Referring to FIG. 2, shown therein is a diagram of a detector 200 for obtaining an electromagnetic emissions program trace of a processor, that is device processor 202, in accordance with at least one embodiment. The device processor 202 can include any electronic device, computer-based device, computing system, or embedded computing system. In some embodiments, the device processor 202 can be a microprocessor, a memory chip, an interface circuit, a processing unit, a CPU, or an electronic control unit.

As shown in FIG. 2, the detector includes a radiofrequency (RF) probe, or antenna 204, an RF amplifier 210, and a capture device 206. The antenna 204 can be placed in the vicinity of the device processor 202 to detect electromagnetic emissions of the device processor 202. In some embodiments, additional signal conditioning is required in order to provide a signal within the operating range of the capture device 206. In some embodiments, the antenna 204 can be cascaded with an RF amplifier 210 to increase the strength of the signal from the antenna 204.

The capture device 206 can measure the output voltage across the antenna 204 in order to obtain the program trace. In addition, the capture device 206 can digitize the program trace. In some embodiments, the capture device 206 can be a contactless current sensor. In some embodiments, the capture device 206 can include an analog-to-digital converter. In some embodiments, the capture device 206 can be a sound card, oscilloscope, or a digital oscilloscope. The program trace obtained by capture device 206 is used by the monitoring system 208 for validating telemetry data or event data of the device processor 202. Although not shown in FIG. 2, the monitoring system 208 can include a monitoring processor, a communication component, and a storage component.

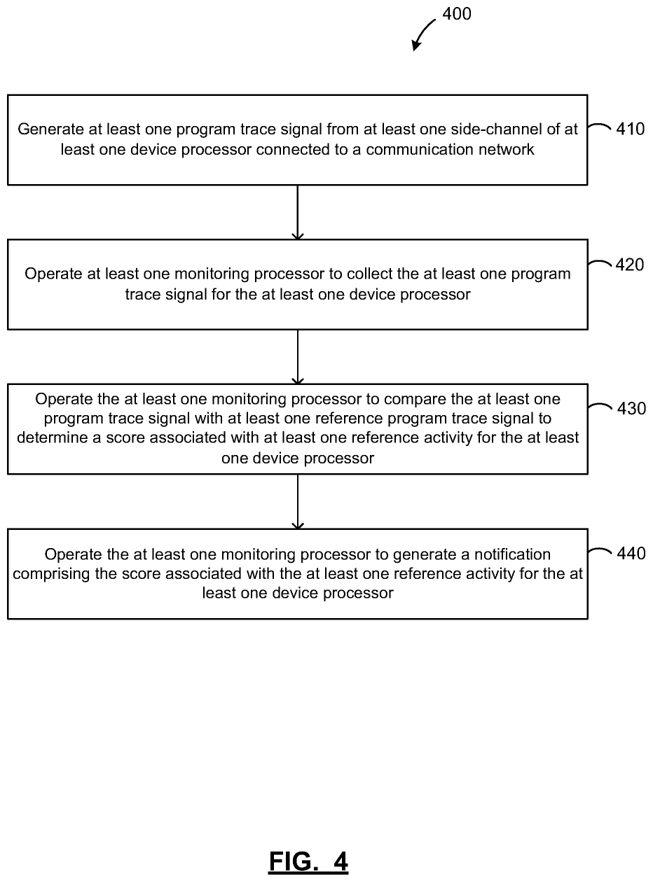

Referring to FIG. 3, shown therein is a diagram of a system 300 for side-channel monitoring of at least one processor connected to a communication network, in accordance with at least one embodiment. The system 300 includes a monitoring processor 302, a communication component 308, a storage component 310, and detectors 312, 314, 316. In some embodiments, each of the monitoring processor 302, the storage component 310 and the communication component 308 may be combined into a fewer number of components or may be separated into further components.

The monitoring processor 302 may be any suitable processors, controllers, digital signal processors, graphics processing units, application specific integrated circuits (ASICs), field programmable gate arrays (FPGAs), microcontrollers, and/or other suitably programmed or programmable logic circuits that can provide sufficient processing power depending on the configuration, purposes and requirements of the monitoring system 302. In some embodiments, the monitoring processor 302 can include more than one processor with each processor being configured to perform different dedicated tasks.

The monitoring processor 302 can be configured to control the operation of the monitoring system 300. The monitoring processor 302 can include modules that initiate and manage the operations of the monitoring system 300. The monitoring processor 302 can also determine, based on received data, stored data and/or user preferences, how the monitoring system 300 may generally operate. The monitoring processor 302 can receive and compare side-channel and primary channel data, generate scores and notifications, transmit notifications via the communication component 308, or store program trace data, scores, and notifications on the storage component 310. The monitoring processor 302 can implement various types of processing such as, but not limited to, digital signal processing, statistical signal processing, statistical pattern recognition, correlation analysis, mutual information analysis, system identification, etc.

The communication component 308 can be any interface that enables the monitoring system 300 to communicate with other devices and systems. In some embodiments, the communication component 308 can include at least one of a serial port, a parallel port or a USB port. The communication component 308 may also include at least one of a CAN bus, an Internet, Local Area Network (LAN), Ethernet, Firewire, modem, fiber, or digital subscriber line connection. Various combinations of these elements may be incorporated within the communication component 308.

For example, the communication component 308 can receive input from various input devices, such as a mouse, a keyboard, a touch screen, a thumbwheel, a track-pad, a track-ball, a card-reader, voice recognition software and the like depending on the requirements and implementation of the monitoring system.

The storage component 310 can include RAM, ROM, one or more hard drives, one or more flash drives or some other suitable data storage elements such as disk drives, etc. The storage component 310 can be used to store an operating system and programs, for example. For instance, the operating system provides various basic operational processes for the monitoring processor 302. The programs include various user programs so that a user can interact with the processor to perform various functions such as, but not limited to, retrieving expected program trace samples as the case may be.

In some embodiments, the storage component 310 can store the program trace signals, information related to the program trace signals, event data, telemetry data, and information related to the event data or the telemetry data. The storage component 310 can include one or more databases (not shown) for storing reference program trace signals, reference activities corresponding to the reference trace signals, information related to the device processors 318, 320, and 322, and information related to the detectors 312, 314, 316.

In this example, the three device processors 318, 320, and 322 are connected to the communication network 330. Each of the device processors 318, 320, and 322 can include any electronic device, computer-based device, computing system, or embedded computing system. In some embodiments, each of the device processors 318, 320, and 322 can be a microprocessor, a memory chip, an interface circuit, a processing unit, a CPU, or an electronic control unit. Although three device processors 318, 320, and 322 are shown in FIG. 3 as being connected to the communication network 330, fewer or more device processors 318, 320, and 322 can be connected to the communication network 330. Furthermore, although the system 300 is shown in FIG. 3 as monitoring all device processors 318, 320, and 322 connected to the communication network 330, the system 300 can monitor only some of device processors 318, 320, and 322 connected to the communication network 330.

The communication network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, controller area network (CAN) bus, and others, including any combination of these, capable of interfacing with, and enabling communication between the monitoring system 300 and the device processors 318, 320, and 322.

Although the monitoring system 300 is shown in FIG. 3 as being connected 304, 306 to the communication network 330, in some embodiments, communications 304 from the monitoring system 300 to device processors 318, 320, and 322 can be indirect. For example, in some embodiments, communications 304 from the monitoring system 300 can be encrypted, via a virtual private network (VPN), or via another communication network (e.g., wireless communication, LTE, Wi-Fi, or a separate local network).

The detectors 312, 314, 316 can obtain program traces of the device processors 318, 320, and 322 connected to the communication network 330. Each of detectors 312, 314, 316, can be any type of detector. For example, one or more of detectors 312, 314, 316 can obtain a power program trace, an EM program trace, a magnetic program trace, an acoustic program trace, or an ultrasound program trace. Any combination of types of detectors 312, 314, 316 can be used to capture multiple program traces. For example, detector 312 can capture a power program trace of device processor 318, while detector 314 can capture an EM program trace of device processor 320, while detector 316 can capture an acoustic program trace of device processor 322.

The system 300 shown in FIG. 3 includes a detector 312, 314, 316 for each of the device processors 318, 320, and 322, respectively. That is, each detector 312, 314, 316 includes a single probe to capture a single program trace, similar to detectors 100 and 200. However, in some embodiments, a detector 312, 314, 316 can include multiple probes to capture multiple program traces from multiple device processors 318, 320, and 322. Furthermore, in some embodiments, multiple program traces for a single device processor 318, 320, and 322 can be captured. For example, both a power program trace and a magnetic program trace can be captured for a single device processor 318, 320, and 322.

Referring now to FIG. 4, an example method 400 of monitoring at least one device processor connected to a communication network is shown in a flowchart diagram. To assist with the description of the method 400, reference will be made simultaneously to FIG. 1 to FIG. 3.

At 410, a detector, such as example detectors 106, 206, 312, 314, and 316, generate at least one program trace signal. The program trace signal can be obtained from a device processor connected to the communication network 330, such as example device processors 102, 202, 318, 320, and 322. As the device processors 102, 202, 318, 320, and 322 operate, a distinct pattern is generated in the power consumption, the magnetic field, and other side-channels such as electromagnetic emissions, acoustic emanations, and ultrasound emanations. The distinct pattern of the side-channels of the device processors 102, 202, 318, 320, and 322 can be correlated to the activity on the device processors 102, 202, 318, 320, and 322.

In some embodiments, the program trace signal can be derived from the power consumption of the device processor 102, such as that obtained by detector 100 via the resistor 104. In some embodiments, the program trace signal can be derived from electromagnetic emissions of the device processor 202, such as that obtained by detector 206 via radio frequency probe 204 and radio frequency amplifier 210. In some embodiments, the program trace signal can be derived from acoustic emanations of the device processors 318, 320, and 322. In some embodiments, the program trace signal can be derived from the magnetic field of the device processors 318, 320, and 322. In some embodiments, the program trace signal can be derived from ultrasound emanations of the device processors 318, 320, and 322.

At 420, at least one monitoring processor, such as monitoring processor 302, is operated to collect the program trace signal generated by the collector at 410.

In some embodiments, the monitoring processor 302 can continuously collect the at least one program trace signal for the device processors 318, 320, 322. In some embodiments, the monitoring processor 302 can collect the program trace signal in response to a query. The query can be received from a user computing device or an external system, such as but not limited to an IDS system, a SIEM system, and/or a SOAR system.

At 430, the at least one monitoring processor 302 is operated to compare the at least one program trace signal with at least one reference program trace signal to determine a score associated with at least one reference activity for the at least one device processor 318, 320, 322. The at least one reference activity can correspond to the at least one reference program trace signal. In some embodiments, each reference activity can corresponds to a different reference program trace signal. In some embodiments, multiple reference activities can correspond to the same reference program trace signal.

The reference program trace signal can be specific to the device processor 318, 320, 322. That is, the same reference activity on different device processors 318, 320, 322 can each correspond to a different reference program trace signal.

In some embodiments, a reference activity can relate to an event that occurs on the device processors 318, 320, and 322. Such events can involve network communication, such as a remote login by an administrator. Events are typically reflected in nominal channels at the device processor 318, 320, and 322 as event data in a log file on the device processor 318, 320, 322. The event data can include a user identifier, a date and time, and an event identifier. When the reference activity relates to an event, the score can represent a likelihood, or a confidence score, of the event occurring on the device processors 318, 320, and 322.

In some embodiments, a reference activity can relate to a metric measurable on the device processors 318, 320, and 322. Metrics are typically reflected in nominal channels at the device processor 318, 320, and 322 as telemetry data transmitted from the device processor 318, 320, and 322. Example metrics can include, but is not limited to CPU usage. Such metrics can be estimated from a program trace signal reflecting the input and/or output activity in the device processors 318, 320, and 322. When the reference activity relates to a metric, the score can represent an estimated value of the metric measurable on the at least one device processor 318, 320, and 322.

As noted above, in some embodiments, the monitoring processor 302 can receive a query for a score associated with a particular reference activity. Having received the query for a particular reference activity, the processor 302 can compare 430 the program trace signal collected at 420 with a reference program trace signal corresponding to the particular reference activity to determine a score associated with the particular reference activity. Determining the score in response to a query can be advantageous for identifying forged or false nominal channel data.

In contrast, in some embodiments, the monitoring processor 302 can continuously collect the program trace signal. The monitoring system 108, 208, and 300 can, in turn, determine the score of reference activities occurring at the device processor 102, 202, 318, 320, and 322. Determining the score of reference activities—not in response to a query—can be advantageous for undocumented activity, which may be malicious.

In some embodiments, the monitoring processor 302 can both, continuously collect the program trace signal and determine the score of reference activities occurring at the processor, and also respond to queries for score of reference activities.

In some embodiments, the monitoring processor 302 can determine whether the score associated with the at least one reference activity correlates to nominal channel data of the device processor 102, 202, 318, 320, and 322. That is, the monitoring processor 302 can compare the information obtained from the side-channel with the information obtained from the nominal channel. The monitoring processor 302 can determine whether the information obtained from the nominal channel is consistent with the information obtained from the side-channel. The monitoring processor 302 can validate the information obtained from the nominal channel based on the information obtained from the side-channel.

In some embodiments, comparing the program trace signal with the reference program trace signal at 440 to determine a score associated with at least one reference activity can involve additional processing including but not limited to digital signal processing, statistical signal processing, such as but not limited to statistical pattern recognition, correlation analysis, mutual information analysis, and system identification. For example, a supervisory learning system can be trained to learn the typical pattern of the program signal for various reference activities, and in particular, various events. Alternatively, a deep learning system can be trained to reconstruct a parameter that is a part of the transmitted telemetry, such as CPU usage, for a given time period.

At 440, the at least one monitoring processor 302 is operated to generate a notification. The notification includes the score obtained at 430. The notification can be transmitted to another computing device, such as but not limited to device processors 318, 320, 322, a user computing device, or an external system, such as an IDS, a SIEM system, and/or a SOAR system. The notification can be transmitted to such other computing devices via the communication network 330.

In some embodiments, the notification can be generated in specific situations. For example, the monitoring processor 302 can generate 440 the notification in response to receiving the query for the score associated with the particular reference activity. In other embodiments, the monitoring processor 302 can generate 440 the notification without being queried. In some embodiments, the monitoring processor 302 can generate 440 the notification in response to determining that the score associated with the at least one reference activity does not correlate to the nominal channel data. That is, that the nominal channel data is not validated based on the side-channel data.

In some embodiments, the monitoring processor 302 can be operated to determine whether the score associated with the at least one reference activity for the device processors 318, 320, and 322 exceeds a predetermined threshold value. In response to determining that the score associated with the at least one reference activity for the device processors 318, 320, and 322 exceeds the predetermined threshold value, the at least one monitoring processor 302 can generate the notification.

As mentioned earlier, in some embodiments, the monitoring processor 302 can include more than one processor. For example, a first monitoring processor 302 can collect 420 the program trace signal and compare 430 the program trace signal with a reference program trace signal to determine a score associated with at least one reference activity for the device processor. The first monitoring processor 302 can transmit the score to a second monitoring processor while a second monitoring processor can receive the score. The second monitoring processor can determine 440 whether the score associated with the at least one reference activity exceeds a predetermined threshold value and generate the notification.

In some embodiments, the second monitoring processor can be external to system 300. For example, the second monitoring processor can be a part of an external system, including but not limited to an IDS, a SIEM system, and/or a SOAR system. The external system can apply any decision algorithm to the side-channel information (e.g., the score transmitted by the first monitoring processor 302) to generate alarms or notifications. Furthermore, the external system can access additional data from other sources and use the additional data in combination with the side-channel information to generate alarms or notifications. For the decision algorithm, the external system can implement various types of processing such as, but not limited to, digital signal processing, statistical signal processing, statistical pattern recognition, correlation analysis, data mining, mutual information analysis, system identification, etc.

In some embodiments, the at least one device processor 318, 320, and 322 can include a first device processor 318 and at least another device processor 320, 322. The method 400 can involve operating the monitoring processor 302 to further determine the score associated with the at least one reference activity for the first device processor 318 based on a comparison of a program trace signal of the first device processor 318 with a program trace signal of the at least another device processor 320, 322. For example, an event of the first device processor 318 may be a remote login by a user at another device processor 320, 322. The score associated with the remote login for the first device processor 318 can be based on the program trace signal of the first device processor 318 as well as the program trace signal of another device processor 320, 322.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for monitoring at least one device processor connected to a communication network, the system comprising:
at least one detector operable to generate at least one program trace signal from at least one side-channel of the at least one device processor; and
at least one monitoring processor in communication with the detector, the at least one monitoring processor being operable to:
collect the at least one program trace signal for the at least one device processor from the at least one detector;
compare the at least one program trace signal with at least one reference program trace signal to determine a score associated with at least one reference activity for the at least one device processor, the at least one reference activity corresponding to the at least one reference program trace signal; and
generate a notification comprising the score associated with the at least one reference activity for the at least one device processor.

2. The system of claim 1, wherein:
the at least one reference activity comprises an event; and
the score comprises a likelihood of the event occurring on the at least one device processor.

3. The system of claim 1, wherein:
the at least one reference activity comprises a metric; and
the score comprises an estimated value of the metric measurable at the at least one device processor.

4. The system of claim 1, wherein the at least one monitoring processor is operable to continuously collect the at least one program trace signal for the at least one device processor.

5. The system of claim 1, wherein the at least one monitoring processor is operable to:
determine whether the score associated with the at least one reference activity for the at least one device processor exceeds a predetermined threshold value; and
generate the notification in response to determining that the score associated with the at least one reference activity for the at least one device processor exceeds the predetermined threshold value.

6. The system of claim 1, wherein the at least one monitoring processor is operable to transmit the notification to another computing device.

7. The system of claim 6, wherein the other computing device comprises one or more of an intrusion detection system (IDS), a security information and event management system (SIEM system), or a security orchestration, automation, and response system (SOAR system).

8. The system of claim 1, wherein the at least one monitoring processor is operable to:
receive a query for a score associated with a particular reference activity of the at least one reference activity;
compare the at least one program trace signal with the reference program trace signal corresponding to the particular reference activity to determine a score associated with the particular reference activity; and
generate the notification in response to receiving the query, the notification comprising the score associated with the particular reference activity.

9. The system of claim 1, wherein the at least one monitoring processor is operable to:
determine whether the score associated with the at least one reference activity correlates to nominal channel data of the at least one device processor; and
generate the notification in response to determining that the score associated with the at least one reference activity does not correlate to the nominal channel data.

10. The system of claim 9, wherein the nominal channel data comprises one or more of event data logged at the at least one device processor or telemetry data measured at the at least one device processor.

11. The system of claim 1, wherein the at least one side-channel comprises one or more of a power consumption, an electromagnetic emission, a magnetic side-channel, an acoustic emanation, or an ultrasound emanation of the at least one device processor.

12. The system of claim 1, wherein:
the at least one reference activity comprises a plurality of reference activities;
the at least one reference program trace signal comprises a plurality of reference program trace signals; and
each reference activity of the plurality of reference activities corresponds to a reference program trace signal of the plurality of reference program trace signals.

13. The system of claim 1, wherein:
the at least one device processor comprises a first device processor and at least another device processor; and
the at least one monitoring processor is operable to further determine the score associated with the at least one reference activity for the first device processor based on a comparison of a program trace signal of the first device processor with a program trace signal of the at least another device processor.

14. A method for monitoring at least one device processor connected to a communication network, the method comprising:
generating at least one program trace signal from at least one side-channel of the at least one device processor; and
operating at least one monitoring processor to:
collect the at least one program trace signal for the at least one device processor;
compare the at least one program trace signal with at least one reference program trace signal to determine a score associated with at least one reference activity for the at least one device processor, the at least one reference activity corresponding to the at least one reference program trace signal; and
generate a notification comprising the score associated with the at least one reference activity for the at least one device processor.

15. The method of claim 14, wherein:
the at least one reference activity comprises an event; and
the score comprises a likelihood of the event occurring on the at least one device processor.

16. The method of claim 14, wherein:
the at least one reference activity comprises a metric; and
the score comprises an estimated value of the metric measurable on the at least one device processor.

17. The method of claim 14, comprising operating the at least one monitoring processor to continuously collect the at least one program trace signal for the at least one device processor.

18. The method of claim 14, comprising operating the at least one monitoring processor to:
determine whether the score associated with the at least one reference activity for the at least one device processor exceeds a predetermined threshold value; and
generate the notification in response to determining that the score associated with the at least one reference activity for the at least one device processor exceeds the predetermined threshold value.

19. The method of claim 14, comprising operating the at least one monitoring processor to transmit the notification to another computing device.

20. The method of claim 19, wherein the other computing device comprises one or more of an intrusion detection system (IDS), a security information and event management system (SIEM system), or a security orchestration, automation, and response system (SOAR system).

21. The method of claim 14, comprising operating the at least one monitoring processor to:
receive a query for a score associated with a particular reference activity of the at least one reference activity;
compare the at least one program trace signal with the reference program trace signal corresponding to the particular reference activity to determine a score associated with the particular reference activity; and
generate the notification in response to receiving the query, the notification comprising the score associated with the particular reference activity.

22. The method of claim 14, comprising operating the at least one monitoring processor to:
determine whether the score associated with the at least one reference activity correlates to nominal channel data of the at least one device processor; and
generate the notification in response to determining that the score associated with the at least one reference activity does not correlate to the nominal channel data.

23. The method of claim 22, wherein the nominal channel data comprises one or more of event data logged at the at least one device processor or telemetry data measured at the at least one device processor.

24. The method of claim 14, wherein the at least one side-channel comprises one or more of a power consumption, an electromagnetic emission, a magnetic side-channel, an acoustic emanation, or an ultrasound emanation of the at least one device processor.

25. The method of claim 14, wherein:
the at least one reference activity comprises a plurality of reference activities;
the at least one reference program trace signal comprises a plurality of reference program trace signals; and
each reference activity of the plurality of reference activities corresponds to a reference program trace signal of the plurality of reference program trace signals.

26. The method of claim 14, wherein:
the at least one device processor comprises a first device processor and at least another device processor; and
the method comprises operating the at least one monitoring processor to further determine the score associated with the at least one reference activity for the first device processor based on a comparison of a program trace signal of the first device processor with a program trace signal of the at least another device processor.
